(19) United States
(12) Patent Application Publication
(10) Pub. No.: US 2023/0065725 A1
(43) Pub. Date: Mar. 2, 2023

(54) PARALLEL DEPTH-WISE PROCESSING ARCHITECTURES FOR NEURAL NETWORKS

(71) Applicant: QUALCOMM Incorporated, San Diego, CA (US)

(72) Inventors: Mustafa BADAROGLU, Leuven (BE); Zhongze WANG, San Diego, CA (US); Francois Ibrahim ATALLAH, Raleigh, NC (US)

(21) Appl. No.: 17/465,550

(22) Filed: Sep. 2, 2021

(51) Int. Cl. G06N 3/08; G06F 7/544; G06N 3/063; G06N 3/04

(52) U.S. Cl. CPC G06N 3/08; G06F 7/5443; G06N 3/063; G06N 3/04

(57) ABSTRACT

Methods and apparatus for performing machine learning tasks, and in particular, to a neural-network-processing architecture and circuits for improved performance through depth parallelism. One example neural-network-processing circuit generally includes a plurality of groups of processing element (PE) circuits, wherein each group of PE circuits comprises a plurality of PE circuits configured to process in parallel an input at a plurality of depths.

### TECHNICAL FIELD

Aspects of the present disclosure relate to machine learning, and in particular, to circuits, neural-network-processing architectures, and techniques for depth-wise parallel processing for executing machine learning tasks.

### BACKGROUND

Machine learning is generally the process of producing a trained model (e.g., an artificial neural network, a tree, or other structures), which represents a generalized fit to a set of training data. Applying the trained model to new data produces inferences, which may be used to gain insights into the new data. In some cases, applying the model to the new data is described as “running an inference” on the new data.

As the use of machine learning has proliferated for enabling various machine learning (or artificial intelligence) tasks, the desire for more efficient processing of machine learning model data has grown. In some cases, dedicated hardware, such as machine learning accelerators, may be used to enhance a processing system's capacity to process machine learning model data. However, such hardware demands space and power, which is not always available on the processing device. For example, “edge processing” devices, such as mobile devices, always-on devices, Internet of Things (IoT) devices, and the like, typically have to balance processing capabilities with power and packaging constraints. Further, accelerators may move data across common data busses, which can cause significant power usage and introduce latency into other processes sharing the data bus. Consequently, other aspects of a processing system are being considered for processing machine learning model data.

### SUMMARY

The systems, methods, and devices of the disclosure each have several aspects, no single one of which is solely responsible for its desirable attributes. Without limiting the scope of this disclosure as expressed by the claims that follow, some features are discussed briefly below. After considering this discussion, and particularly after reading the section entitled “Detailed Description,” one will understand how the features of this disclosure provide the advantages described herein.

Certain aspects of the present disclosure are directed to a processing circuit. The processing circuit generally includes a plurality of groups of processing element (PE) circuits. Each group of PE circuits comprises a plurality of PE circuits configured to process in parallel an input at a plurality of depths. Each PE circuit generally includes one or more multiplication circuits and a local accumulator having an input coupled to an output of the one or more multiplication circuits. Each multiplication circuit may be configured to calculate a partial product, and the local accumulator may be configured to generate a sum from the partial product calculated by each of the one or more multiplication circuits.

Certain aspects of the present disclosure are directed to a method of neural network processing. The method generally includes receiving an input for processing. For each segment of a plurality of segments of the received input, an intermediate output for a respective depth of a plurality of depths in a neural network is generated substantially in parallel based on weights in the neural network associated with the respective depth. The intermediate output for each respective depth is accumulated into a final output. At least the final output is outputted to a memory bus.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIGS. 1A-1D depict examples of various types of neural networks, which may be implemented by aspects of the present disclosure.

FIG. 2 depicts an example of a traditional convolution operation, which may be implemented by aspects of the present disclosure.

FIG. 3 is a block diagram of an example neural-network-processing architecture with tightly coupled memory (TCM) and processing elements (PEs), in which certain aspects of the present disclosure may be implemented.

FIG. 4 illustrates processing element utilization in a neural-network-processing architecture in which different depths of an input are processed serially.

FIG. 5 illustrates an example neural-network-processing architecture in which multiple processing element groups are configured to process a plurality of depths of a plurality of inputs in parallel, in accordance with certain aspects of the present disclosure.

FIG. 6 illustrates an example dataflow timing diagram for processing different depths of multiple inputs in parallel, in accordance with certain aspects of the present disclosure.

FIG. 7 is a block diagram of an example circuit for depth-wise parallel processing of an input, in accordance with certain aspects of the present disclosure.

FIG. 8 illustrates processing element utilization in a neural-network-processing architecture in which different depths of an input are processed in parallel.

FIG. 9 illustrates example operations that may be performed by a processing system to process a plurality of depths of an input in parallel, in accordance with certain aspects of the present disclosure.

FIG. 10 is a block diagram illustrating an example electronic device having a neural-network-processing circuit in which a plurality of depths of an input are processed in parallel, in accordance with certain aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for processing a plurality of depths of an input in parallel.

### Brief Introduction to Neural Networks, Deep Neural Networks, and Deep Learning

Neural networks are organized into layers of interconnected nodes. Generally, a node (or neuron) is where computation happens. For example, a node may combine input data with a set of weights (or coefficients) that either amplifies or dampens the input data. The amplification or dampening of the input signals may thus be considered an assignment of relative significances to various inputs with regard to a task the network is trying to learn. Generally, input-weight products are summed (or accumulated), and then the sum is passed through a node's activation function to determine whether and to what extent that signal should progress further through the network.

In a most basic implementation, a neural network may have an input layer, a hidden layer, and an output layer. “Deep” neural networks generally have more than one hidden layer.

Deep learning is a method of training deep neural networks. Generally, deep learning maps inputs to the network to outputs from the network and is thus sometimes referred to as a “universal approximator” because deep learning can learn to approximate an unknown function f(x)=y between any input x and any output y. In other words, deep learning finds the right f to transform x into y.

More particularly, deep learning trains each layer of nodes based on a distinct set of features, which is the output from the previous layer. Thus, with each successive layer of a deep neural network, features become more complex. Deep learning is thus powerful because it can progressively extract higher-level features from input data and perform complex tasks, such as object recognition, by learning to represent inputs at successively higher levels of abstraction in each layer, thereby building up a useful feature representation of the input data.

For example, if presented with visual data, a first layer of a deep neural network may learn to recognize relatively simple features, such as edges, in the input data. In another example, if presented with auditory data, the first layer of a deep neural network may learn to recognize spectral power in specific frequencies in the input data. The second layer of the deep neural network may then learn to recognize combinations of features, such as simple shapes for visual data or combinations of sounds for auditory data, based on the output of the first layer. Higher layers may then learn to recognize complex shapes in visual data or words in auditory data. Still higher layers may learn to recognize common visual objects or spoken phrases. Thus, deep learning architectures may perform especially well when applied to problems that have a natural hierarchical structure.

### Layer Connectivity in Neural Networks

Neural networks, such as deep neural networks (DNNs), may be designed with a variety of connectivity patterns between layers.

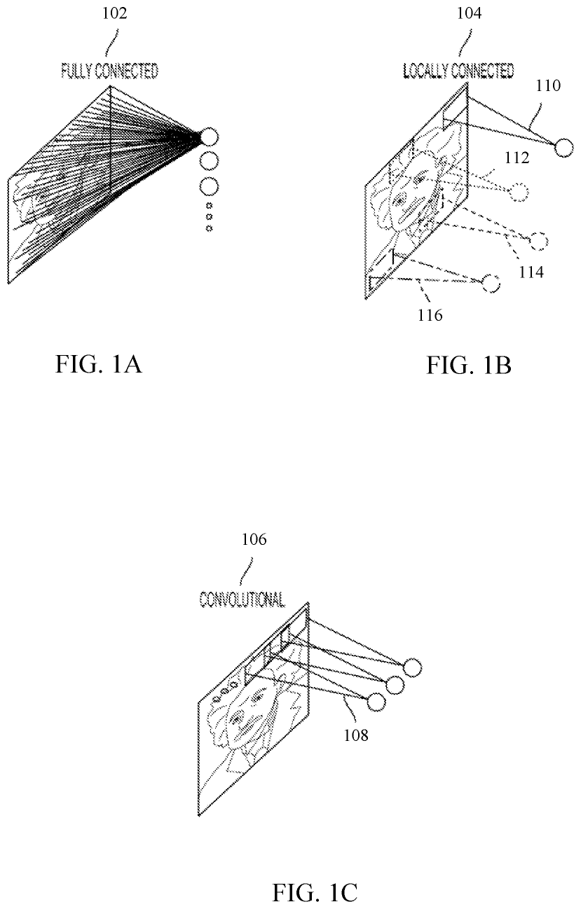

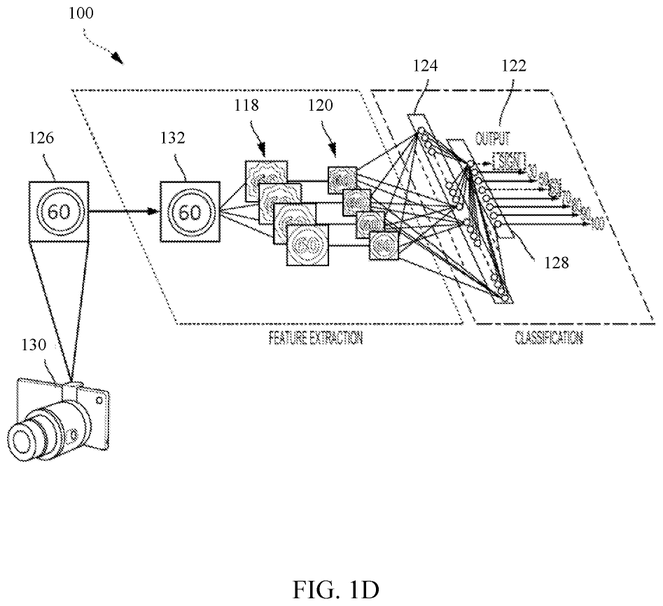

FIG. 1A illustrates an example of a fully connected neural network 102. In a fully connected neural network 102, each node in a first layer communicates its output to every node in a second layer, so that each node in the second layer will receive input from every node in the first layer.

FIG. 1B illustrates an example of a locally connected neural network 104. In a locally connected neural network 104, a node in a first layer may be connected to a limited number of nodes in the second layer. More generally, a locally connected layer of the locally connected neural network 104 may be configured so that each node in a layer will have the same or a similar connectivity pattern, but with connection strengths (or weights) that may have different values (e.g., values associated with local areas 110, 112, 114, and 116 of the first layer nodes). The locally connected connectivity pattern may give rise to spatially distinct receptive fields in a higher layer, because the higher layer nodes in a given region may receive inputs that are tuned through training to the properties of a restricted portion of the total input to the network.

One type of locally connected neural network is a convolutional neural network (CNN). FIG. 1C illustrates an example of a convolutional neural network 106. The convolutional neural network 106 may be configured such that the connection strengths associated with the inputs for each node in the second layer are shared (e.g., for local area 108 overlapping another local area of the first layer nodes). Convolutional neural networks are well suited to problems in which the spatial locations of inputs are meaningful.

One type of convolutional neural network is a deep convolutional network (DCN). Deep convolutional networks are networks of multiple convolutional layers, which may further be configured with, for example, pooling and normalization layers.

FIG. 1D illustrates an example of a DCN 100 designed to recognize visual features in an image 126 generated by an image-capturing device 130. For example, if the image-capturing device 130 is a camera mounted in or on (or otherwise moving along with) a vehicle, then the DCN 100 may be trained with various supervised learning techniques to identify a traffic sign and even a number on the traffic sign. The DCN 100 may likewise be trained for other tasks, such as identifying lane markings or identifying traffic lights. These are just some example tasks, and many others are possible.

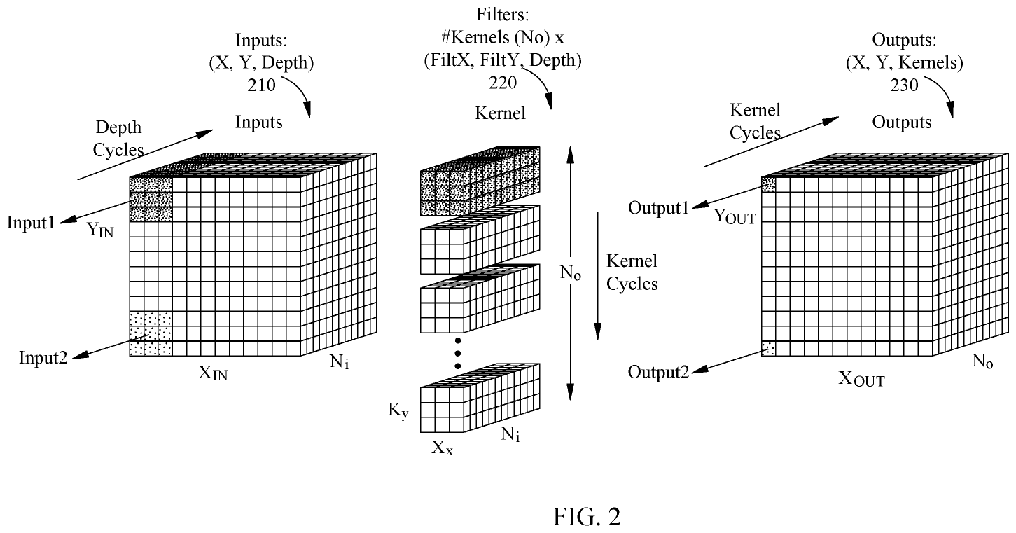

In the example of FIG. 1D, the DCN 100 includes a feature-extraction section and a classification section. Upon receiving the image 126, a convolutional layer 132 applies convolutional kernels (for example, as depicted and described in FIG. 2) to the image 126 to generate a first set of feature maps 118 (or intermediate activations). Generally, a “kernel” or “filter” comprises a multidimensional array of weights designed to emphasize different aspects of an input data channel. In various examples, “kernel” and “filter” may be used interchangeably to refer to sets of weights applied in a convolutional neural network.

The first set of feature maps 118 may then be subsampled by a pooling layer (e.g., a max pooling layer, not shown) to generate a second set of feature maps 120. The pooling layer may reduce the size of the first set of feature maps 118 while maintaining much of the information in order to improve model performance. For example, the second set of feature maps 120 may be downsampled to a 14×14 matrix from a 28×28 matrix by the pooling layer.

This process may be repeated through many layers. In other words, the second set of feature maps 120 may be further convolved via one or more subsequent convolutional layers (not shown) to generate one or more subsequent sets of feature maps (not shown).

In the example of FIG. 1D, the second set of feature maps 120 is provided to a fully connected layer 124, which in turn generates an output feature vector 128. Each feature of the output feature vector 128 may include a number that corresponds to a possible feature of the image 126, such as “sign,” “60,” and “100.” In some cases, a softmax function (not shown) may convert the numbers in the output feature vector 128 to a probability. In such cases, an output 122 of the DCN 100 is a probability of the image 126 including one or more features.

A softmax function (not shown) may convert the individual elements of the output feature vector 128 into a probability in order that an output 122 of DCN 100 is one or more probabilities of the image 126 including one or more features, such as a sign with the number “60” thereon, as in image 126. Thus, in the present example, the probabilities in the output 122 for “sign” and “60” should be higher than the probabilities of the other elements of the output 122, such as “30,” “40,” “50,” “70,” “80,” “90,” and “100.”

Before training the DCN 100, the output 122 produced by the DCN 100 may be incorrect. Thus, an error may be calculated between the output 122 and a target output known a priori. For example, here the target output is an indication that the image 126 includes a “sign” and the number “60.” Utilizing the known target output, the weights of the DCN 100 may then be adjusted through training so that a subsequent output 122 of the DCN 100 achieves the target output (with high probabilities).

To adjust the weights of the DCN 100, a learning algorithm may compute a gradient vector for the weights. The gradient vector may indicate an amount that an error would increase or decrease if a weight were adjusted in a particular way. The weights may then be adjusted to reduce the error. This manner of adjusting the weights may be referred to as “backpropagation” because this adjustment process involves a “backward pass” through the layers of the DCN 100.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After training, the DCN 100 may be presented with new images, and the DCN 100 may generate inferences, such as classifications, or probabilities of various features being in the new image.

### Convolution Techniques for Convolutional Neural Networks

Convolution is generally used to extract useful features from an input data set. For example, in convolutional neural networks, such as described above, convolution enables the extraction of different features using kernels and/or filters whose weights are automatically learned during training. The extracted features are then combined to make inferences.

An activation function may be applied before and/or after each layer of a convolutional neural network. Activation functions are generally mathematical functions that determine the output of a node of a neural network. Thus, the activation function determines whether a node should pass information or not, based on whether the node's input is relevant to the model's prediction. In one example, where y=conv(x) (i.e., y is the convolution of x), both x and y may be generally considered as “activations.” However, in terms of a particular convolution operation, x may also be referred to as “pre-activations” or “input activations” as x exists before the particular convolution, and y may be referred to as output activations or a feature map.

FIG. 2 depicts a three-dimensional convolution in which an input 210 is organized into a three-dimensional space and processed using a plurality of convolution kernels 220 to generate outputs 230. Input 210 may be a three-dimensional input, such as a three-dimensional image with spatial data in each of the three dimensions (e.g., the X (horizontal) dimension, the Y (vertical) dimension, and the Z (depth) dimension), or a sequence of two-dimensional images (having X (horizontal) and Y (vertical) dimensions) over time (e.g., video), where time may correspond to the Z (depth) dimension. In this particular example, a 12-pixel by 12-pixel image having some number n of depth cycles may be processed through a corresponding convolution kernel 220 having dimensions of 3 pixels by 3 pixels by n depth cycles. The output 230 may have the same size along the X and Y dimensions and a depth dimension corresponding to the number of convolution kernels 220 used to process the input 210.

An output stationary technique, in which outputs of a neural network remain stored in memory associated with a processing element, may allow for rapid generation of output 230. Generally, using output-stationary techniques involves depth cycles (corresponding to different kernels from the plurality of convolution kernels 220) being located in an inner loop of a multi-loop logical structure, where the outer loop of the multi-loop logical structure is used to iterate over the X and Y dimensions. Output-stationary techniques, however, may allow for accumulator circuits to be reused over the depth cycles for a given input in the X and Y dimensions. However, each depth cycle generally entails reloading weights associated with that depth cycle into a processing element used to process the depth cycle. Further, when a kernel is updated, the inputs in the X and Y dimensions may be reloaded into one or more processing elements and processed. Some processing techniques may support weight-stationary processing of an input. In such a case, an input in the X and Y dimensions may be iterated over within the inner loop of a multi-loop structure.

### Example Neural-Network-Processing Architectures and Dataflow

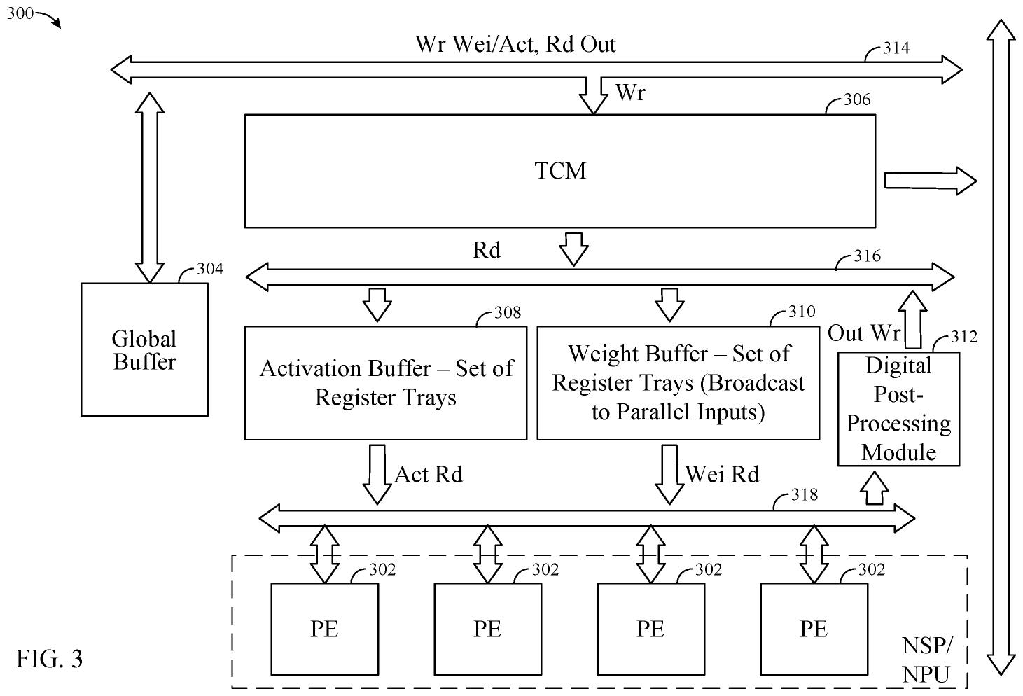

FIG. 3 is a block diagram of an example neural-network-processing architecture 300, illustrating an example dataflow sequence, in which certain aspects of the present disclosure may be implemented. The neural-network-processing architecture 300 may include a plurality of processing elements (PEs) 302 for performing data computation (e.g., multiply-and-accumulate (MAC) operations) and other operations. The PEs 302 may be implemented with any of various suitable circuits, such as neural processing units (NPUs), neural signal processors (NSPs), or compute-in-memory (CIM) circuits. The processing architecture 300 may also include a global memory 304 (labeled “Global Buffer”), a tightly coupled memory (TCM) 306, an activation buffer 308, a weight buffer 310, a digital post-processing module 312, a memory bus 314, a register bus 316, and a PE bus 318. As used herein, a TCM generally refers to a memory accessed by a dedicated connection from the processor(s), such as the PEs 302. The activation buffer 308 and weight buffer 310 may each be structured as sets of register trays. The data stored in the weight buffer 310 may be broadcast to parallel inputs (e.g., inputs processed in parallel by the PEs 302). The memory bus 314 may couple the global memory 304 to the TCM 306. The register bus 316 may couple the TCM 306 to the activation buffer 308, weight buffer 310, and digital post-processing module 312. The PE bus 318 may couple the PEs 302 to the activation buffer 308, weight buffer 310, and digital post-processing module 312. In this manner, the PEs 302 may access the various memory resources to read data from the activation buffer 308 and/or weight buffer 310 and output a result of processing the data read from the activation buffer 308 and/or weight buffer 310 to the digital post-processing module 312.

### Example Parallel Processing of Depths of an Input

Parallel processing generally allows for multiple portions or segments of an input to be processed by a processing unit, such as a neural signal processor (NSP) or neural processing unit (NPU), substantially at the same time. Generally, parallel processing may leverage the independence of various inputs to accelerate processing of a set of inputs and complete execution of an operation on a set of inputs using fewer compute resources (e.g., time) and/or more efficient usage of compute resources (e.g., a proportion of used compute resources to total compute resources available in a computing system) than would be used in serial processing of the set of inputs. Typically, NSPs or NPUs may be designed to support input parallelism for different portions of an input (e.g., defined chunks of a two-dimensional input, such as a block of pixels in an image) and to process these portions of the input at different depths (e.g., different channels or times) sequentially (e.g., using different kernel (depth) cycles, as discussed above with respect to FIG. 2). That is, for input portion indices {1, 2, 3, . . . , n} and a depth of m, these NSPs or NPUs may be designed to process values at input portion indices {1, 2, 3, . . . , n} at depth 1, then values at input portion indices {1, 2, 3, . . . , n} at depth 2, and so on, up to depth m. Because these NSPs or NPUs may be designed to support depth-sequential processing, the capabilities of these NSPs or NPUs may not be fully utilized. Further, increases in the depth of a neural network may compound the effect of not fully utilizing the processing capabilities of an NSP or NPU, thus negatively impacting performance metrics of these NSPs or NPUs as the depth of a neural network increases. For example, given some maximum number of operations per second that an NSP or NPU could support when all processing elements (PEs) in the NSP or NPU are used, the number of operations per second that the NSP or NPU can support when using depth-sequential processing may be significantly lower.

To allow for increased performance, processing elements in an NSP or NPU may be designed to support an increased activation depth. However, increasing the activation depth supported by a processing element may reduce mapping flexibility, reduce clock frequency, and/or reduce the number of inputs that can be processed in parallel using the same hardware resources.

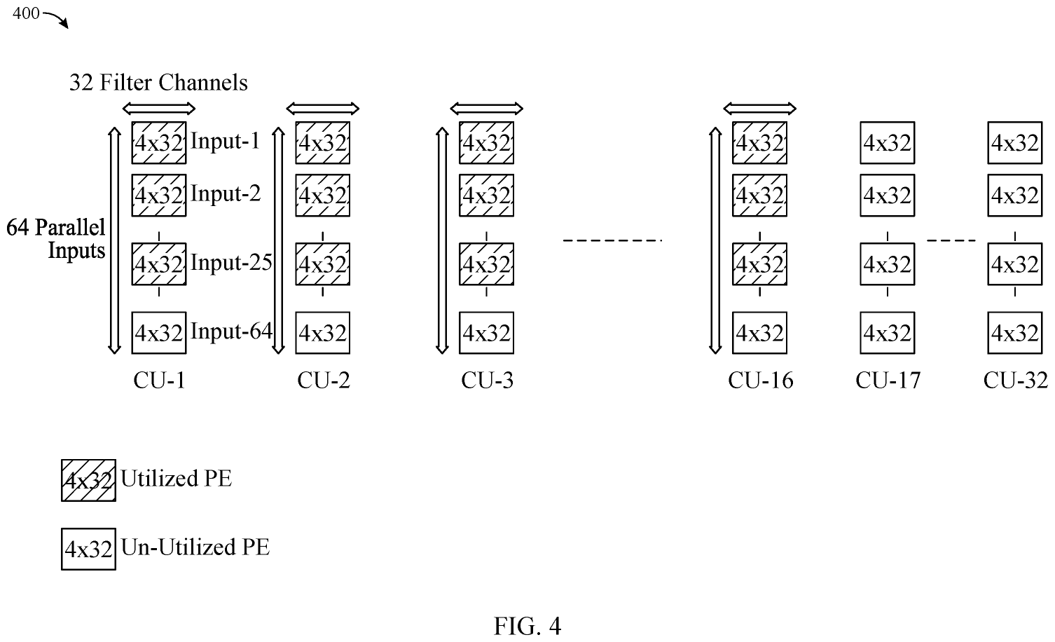

FIG. 4 illustrates an example 400 of processing element utilization in a neural-network-processing architecture in which an input is processed serially at different depths in a neural network. In example 400, the architecture may support input parallelism and filter channel parallelism such that multiple segments of an input (e.g., in the X and Y dimension as shown in FIG. 2) can be processed in parallel using multiple filters in parallel, but may not support depth parallelism in which the same segment of an input can be processed at different depths in the neural network (e.g., using different kernels). As illustrated, the architecture in example 400 may have 32 computing units (labeled “CU-1” through “CU-32”), and each of these computing units may include 64 processing elements (PEs) that can be used to process portions of an input provided to the architecture in parallel. Each PE may be configured to process 4 activations and 32 filter channels. In this example, a layer of a ResNet50 network may have an input tensor of size 7×7×512 and a number of corresponding kernel tensors of size 3×3×512. For any 7×7 input channel, 25 operations may be performed to convolve 25 different, though potentially overlapping, receptive fields with a 3×3 kernel using a stride distance of 1. In this example, a 5×5 feature map may be generated as the output of this layer. Input segments 1 through 25 may be processed through the corresponding processing elements in computing units 1 through 16 of the architecture, as shown. However, because the architecture may not support depth-wise parallelism, computing resources that could be used for processing inputs at another depth may instead be left unused.

Thus, in example 400, a significant amount of computing resources may be unused, and performance may not be scalable. For example, resource utilization may be calculated as the product of a number of computing units over which a problem is executed, a number of inputs, a number of activations, and a number of filter channels. In this example, as discussed, a problem may be defined according to the following parameters: depth=512, InputX=7, InputY=7, FilterX=3, FilterY=3, StrideX=1, and StrideY=1. As illustrated, there are four activations and 32 filter channels for each PE, and 25 input segments processed over 16 computing units out of 32 computing units since 512 filter channels are mapped over 16 computing units where each computing unit has 32 filter channels; and 25 input segments are mapped over 25 out of 128 activation inputs. There is no further utilization of remaining 16 out of 32 computing units because the architecture used in example 400 does not support depth-wise parallelism. A number of depth cycles executed to complete this problem may be calculated as FilterX*FilterY*Depth/Activations=3*3*512/4=1152 depth cycles, and the utilization efficiency compared to a maximum theoretical usage may be (16*25*4*32)/(32*64*4*32)=20%. Further, because the utilization efficiency is low, the number of operations supported over a given period of time may similarly be less than a maximum theoretical number of operations supported over this given period of time assuming full utilization of the resources of the architecture.

Aspects of the present disclosure provide techniques for performing depth-wise parallel processing of input portions in a neural-network-processing architecture. By allowing for both input parallelism and depth parallelism, aspects of the present disclosure may allow for increased utilization of computing resources (e.g., processing elements) in such an architecture. Thus, the techniques described herein may improve inference performance by a neural-network-processing architecture, as increased utilization of available computing resources in the architecture may result in an increased number of operations that can be performed by the architecture relative to architectures that are designed to support depth-sequential processing.

Further, aspects of the present disclosure provide a scalable processing architecture that allows for various types of parallel processing to be implemented for any given workload. The processing architectures described herein may allow for a choice of processing a workload using parallel inputs, parallel kernels, or parallel depths. Further, because (a portion of) an input may be processed in parallel at different depths, aspects of the present disclosure may reduce the number of processing cycles needed to process a number of depth cycles in a neural network.

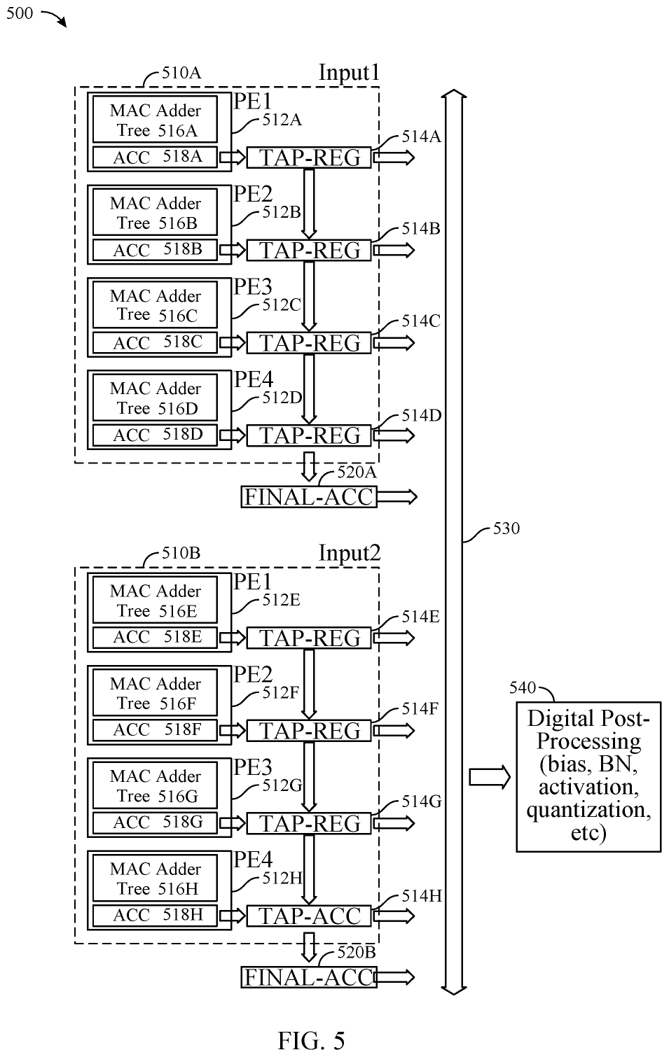

FIG. 5 illustrates an example of a neural-network-processing architecture 500 in which multiple processing element groups are configured to process a plurality of portions of an input at a plurality of depths in parallel, in accordance with certain aspects of the present disclosure. Generally, the portions of the input may be defined by a tiling pattern used to divide the input. Tiling patterns with smaller numbers of tiles may generally divide an input into larger sub-portions, while tiling patterns with larger numbers of tiles may generally divide an input into smaller sub-portions. The choice of tiling pattern used in dividing the input into different portions for processing may represent a tradeoff between performance of and accuracy of inferences generated by the neural network. Using larger numbers of tiles may allow for data to be processed in the neural network at a more granular level, but with greater computational expense, while using smaller numbers of tiles (and correspondingly, larger sub-portions of an input) may allow for data to be processed in the neural network at a lesser computational expense, but with a higher degree of generality.

As illustrated, neural-network-processing architecture 500 may include a plurality of processing element groups 510 configured to process a plurality of inputs (or portions of an input) at a plurality of depths in parallel. In this example architecture, two processing element groups 510A and 510B are shown, although the reader is to understand that there may be more than two processing element groups. Each processing element group 510 may include a plurality of processing elements 512, and the output of each processing element may be output to an associated tap register 514. In this example, processing element group 510A includes four processing elements 512A-512D, and processing element group 510B includes four processing elements 512E-512H, although the reader is to understand that each processing element group may include more or less than four processing elements. As illustrated, each processing element 512 includes a multiply-and-accumulate (MAC) circuit 516 and a local accumulator 518 having an input coupled to an output of the MAC circuit. The output of the local accumulator 518 in a processing element 512 may be coupled to an input of the corresponding tap register 514. In some aspects, the MAC circuit 516 may include a plurality of multiplier circuits configured to generate partial products based on multiplying input values with weight values, and the local accumulator 518 may be implemented as an adder circuit configured to combine the partial products generated by the individual multipliers in the MAC circuit 516 into a local sum.

Generally, the tap registers 514 within a processing element group 510 may be coupled such that the output of one tap register 514 serves as an input to another tap register 514. The output of a final tap register (e.g., tap register 514D or 514H) within a processing element group 510 may be coupled to an input of a global accumulator circuit 520 (also referred to as a “final accumulator” and labeled “FINAL-ACC”). For each depth cycle processed in parallel, a given tap register 514 may be configured to shift the data provided as input from a predecessor tap register 514 concurrently with a multiply-and-accumulate operation performed by a processing element 512 corresponding to the given tap register 514. For example, tap register 514B may be configured to shift the data provided as input from tap register 514A concurrently with an operation performed by processing element 512B.

An output of the global accumulator circuit 520 may be coupled to a bus 530 connecting the processing element groups 510 with digital post-processing logic 540. Generally, the value of the global accumulator circuit 520 may be used by the digital post-processing logic 540 in further processing the input data from which the value of the global accumulator circuit 520 was generated (e.g., biasing, batch normalization (BN), linear/non-linear thresholding, quantization, etc.). In some aspects, the outputs of the tap registers 514 may also be coupled to the bus 530. Bus 530 may be, in such a case, an addressable bus allowing the digital post-processing logic 540 to selectively obtain data placed on bus 530 by the global accumulator circuits 520 (and tap registers 514).

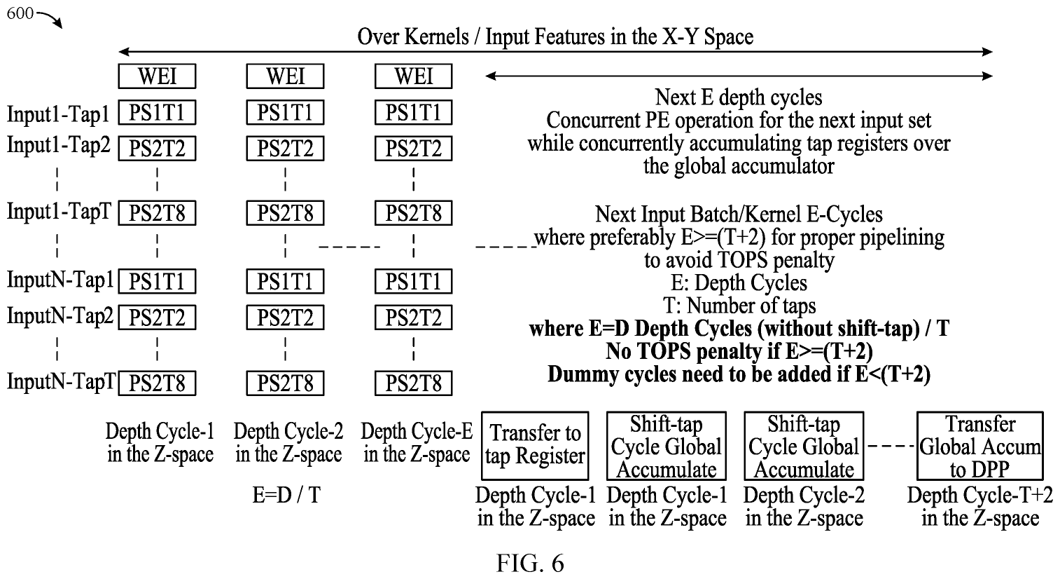

FIG. 6 illustrates an example dataflow timing diagram 600 for processing different depths of multiple inputs in parallel, in accordance with certain aspects of the present disclosure. In this example, an input may be defined as a portion of a larger input data set, such as data values at a set of coordinates in a three-dimensional space having X, Y, and Z axes, where the depth dimension corresponds to the Z axis in the three-dimensional space. As illustrated in the timing diagram 600, processing architecture 500 supports processing a plurality of inputs over a plurality of depth cycles in the Z axis in parallel. Generally, each depth cycle may be associated with a set of weights used in calculating a result at that depth cycle defined in the model.

As illustrated, over a number E of depth cycles, portions of an input may be processed concurrently. For example, over the E depth cycles, portions of an input located at the same location in a first and second dimension and different locations in a third dimension may be processed concurrently. Values stored in the tap registers for the input may be accumulated over the global accumulator (e.g., through a serial shift) as these inputs are processed. After a given depth cycle is executed, the value stored in the global accumulator may be output to digital post-processing logic for further use. To minimize negative impacts on the number of operations over a time period supported by a neural-network-processing architecture, the number T of taps (e.g., 8 taps, as illustrated in FIG. 6) may be determined (e.g., calculated or selected) based on the number of depth cycles E over which a portion of the input is provided and processed in parallel. For example, where E=total depth cycles D/number of taps T, there may be little or no negative impact to the processing capabilities of the neural-network-processing architecture (e.g., few or no unused processing elements) when E>T+2. In cases where E<T+2, dummy cycles may be added to minimize negative impacts on the number of operations over a time period supported by the neural-network-processing architecture.

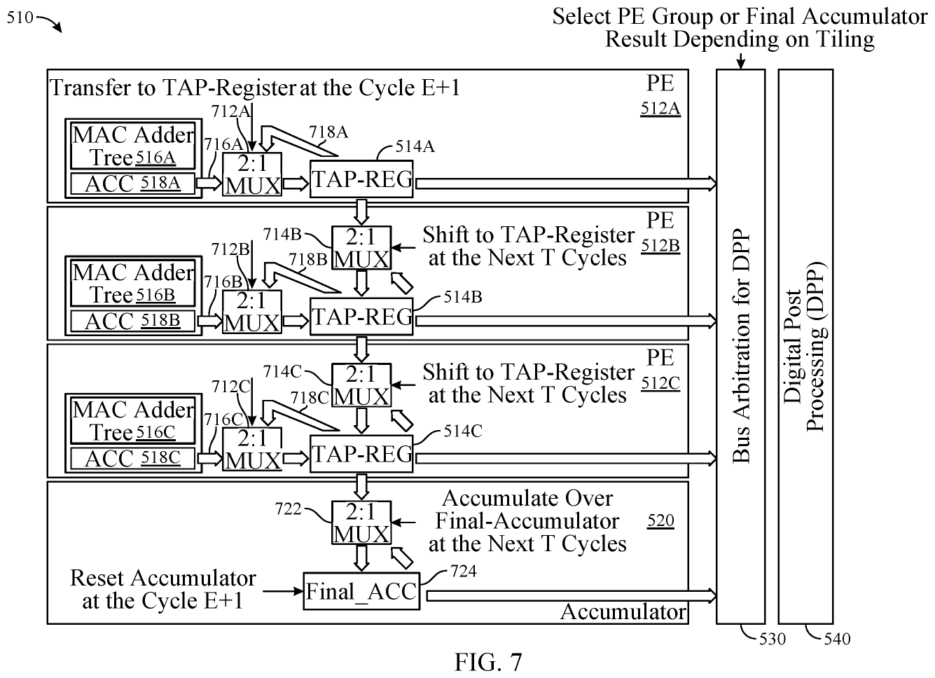

FIG. 7 is a block diagram of an example circuit for depth-wise parallel processing of an input portion, in accordance with certain aspects of the present disclosure. The example circuit in FIG. 7 includes a more detailed version of the processing elements 512 in FIG. 5. As illustrated in FIG. 7, a processing element group 510 of a neural-network-processing circuit configured to concurrently process a plurality of depths of an input portion may include a plurality of processing elements 512 and a global accumulator circuit 520. The neural-network-processing circuit may include multiple processing element groups 510, and each processing element group 510 in the neural-network-processing circuit may be configured to process a different portion of the input at the plurality of depths.

Each processing element 512, as illustrated, generally includes a multiply-and-accumulate (MAC) circuit 516 (e.g., a MAC adder tree) and a local accumulator 518. Generally, the MAC circuit 516 can generate a result of a mathematical operation on a given input and output the result of the mathematical operation to local accumulator 518. The output of local accumulator 518 may be provided as an input, along with the value stored in a corresponding tap register 514, to a selection circuit 712. The selection circuit 712 may be, for example, a multiplexer circuit (e.g., a 2:1 multiplexer in which one of two values input into the multiplexer is output based on the value of a selector control signal), a tri-state buffer, a plurality of switches, or other circuitry that allows for the selection of either the output value 716 from the local accumulator 518 or the output value 718 from the tap register 514 to be output to the input of the tap register 514. Generally, when the local accumulator 518 finishes calculating the final accumulation result at the end of E depth cycles (e.g., after E depth cycles are processed), the selector control signal may control the selection circuit 712 to select the output of the local accumulator 518 as the input into the tap register 514. That is, the selector control signal may go to a high value when the number of depth cycles reaches E. Otherwise, the selection circuit 712 can select the current value of the tap register 514 as the input of the tap register 514 to preserve the data currently stored in the tap register.

At some processing elements 512, a second selection circuit 714 may be used to impact the value stored in the tap register 514. The second selection circuit 714 may be used, for example, in processing elements subsequent to an initial processing element used for an input at a first depth cycle. That is, for an input at a first depth cycle processed by initial processing element 512A, subsequent processing elements 512B and 512C (and other processing elements subsequent to the processing element 512A) may use a respective second selection circuit 714 to impact the value stored in the respective tap register 514 for the processing element. Like selection circuit 712, the second selection circuit 714 may be implemented, for example, by a multiplexer circuit (e.g., a 2:1 multiplexer in which one of two values input into the multiplexer is output based on the value of a selector input), a tri-state buffer, a plurality of switches, or other circuitry that allows for the selection of one of a plurality of values. A control signal, such as a signal to shift out the value of the tap register 514 over a number of depth cycles equal to the number of taps T, may be used to control the value stored in the tap register 514. The value selected by the second selection circuit 714 may be the current value of the tap register 514 or the value of a tap register 514 in a predecessor processing element (e.g., as illustrated, at processing element 512B, the output of the tap register 514A of processing element 512A). For processing elements 512B and 512C, thus, the tap register 514B (and 514C) may have a first input coupled to an output of selection circuit 712B (and 712C) and a second input coupled to an output of second selection circuit 714B (and 714C).

Global accumulator circuit 520 includes a selection circuit 722 and a global accumulator 724. The selection circuit 722 may take, as input, the current value in the global accumulator 724 and the output of the tap register 514 associated with the last processing element used to process the input at a defined number of depths (e.g., as illustrated, tap register 514C associated with processing element 512C). A selector input into selection circuit 722 may be used to set the value of global accumulator 724 such that the value stored in global accumulator 724 is accumulated over a number of depth cycles. Generally, after E cycles are processed (e.g., at depth cycle E+1), the value stored in global accumulator 724 may be output to bus 530, and the global accumulator circuit 520 may be reset.

Bus 530 generally is coupled with an output of one or more tap registers 514 associated with the one or more processing elements 512 and an output of a global accumulator 724 in the accumulator circuit 520. Generally, bus 530 may arbitrate data requests from and data dispatch to digital post-processing logic 540. For example, bus 530 may select which outputs to make available to digital post-processing logic 540 based on the tiling defined for a neural network executing on the neural-network-processing circuit. The values made available to the digital post-processing logic 540 through bus 530 may thus include one or more of a value output by a processing element 512, outputs output by a plurality of processing elements 512, and/or a value stored in global accumulator 724 and output to bus 530.

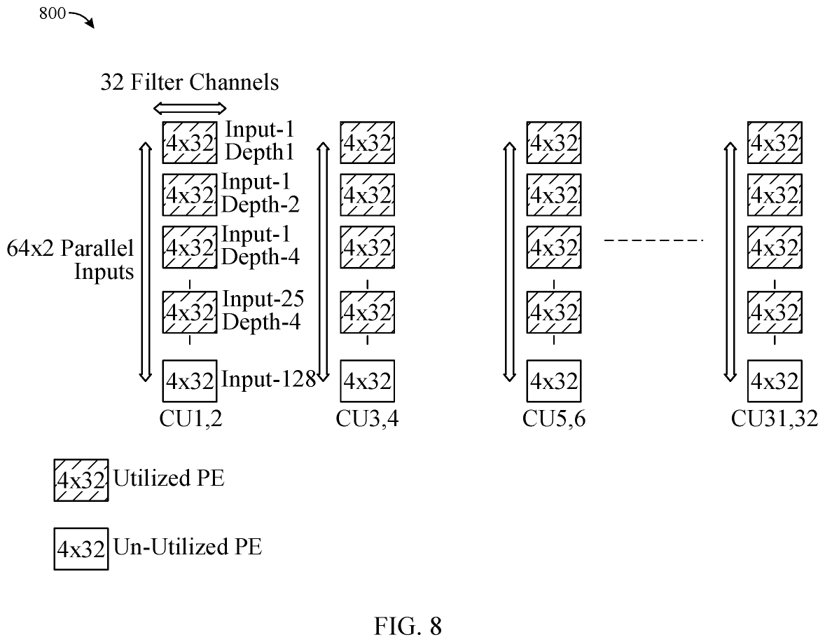

FIG. 8 illustrates an example 800 of processing element utilization in a neural-network-processing architecture in which different depths of a portion of an input are processed in parallel. As illustrated, a plurality of computing units may be aggregated to support processing of the portion of the input at multiple depths. In this example, for a computing unit supporting 64 input portions, two computing units may be aggregated to form a virtual computing unit supporting 128 inputs. Each processing element may process an input using four activations and 32 filter channels. As illustrated, 25 portions of an input (e.g., 25 different segments of an image) may be processed in parallel at four different depths (e.g., based on a ResNet 50 layer having an input tensor of size 7×7×512 and a number of corresponding kernel tensors of size 3×3×512 and convolving 25 different fields). Because the input portions can be processed in parallel at different depths of the neural network, a significantly smaller number of processing element circuits may be unused relative to the number of unused processing element circuits illustrated in FIG. 4. In this example, a problem processed using the neural-network-processing architectures described herein in which different depths of an input may be processed in parallel may be defined according to the parameters discussed above with respect to FIG. 4 (e.g., depth=512, InputX=7, InputY=7, FilterX=3, FilterY=3, StrideX=1, and StrideY=1). The number of clock cycles over which the problem is processed may be defined as FilterX*FilterY*Depth/Activations=3*3*512/4/5=231 cycles, or about 20% of the number of cycles used in depth-sequential processing discussed above. The utilization efficiency compared to a maximum theoretical usage may be (32*50*4*32)/(32*64*4*32)=78%. Further, the number of operations per second may be significantly increased relative to the number of operations per second that can be performed in depth-sequential processing of inputs through a neural processing architecture operating at the same clock rate. Thus, as illustrated, fewer computing resources may be wasted by processing inputs using depth parallelism, and the overall performance of a neural processing architecture may be improved over the performance of a neural processing architecture that processes inputs using depth-serial processing.

### Example Operations

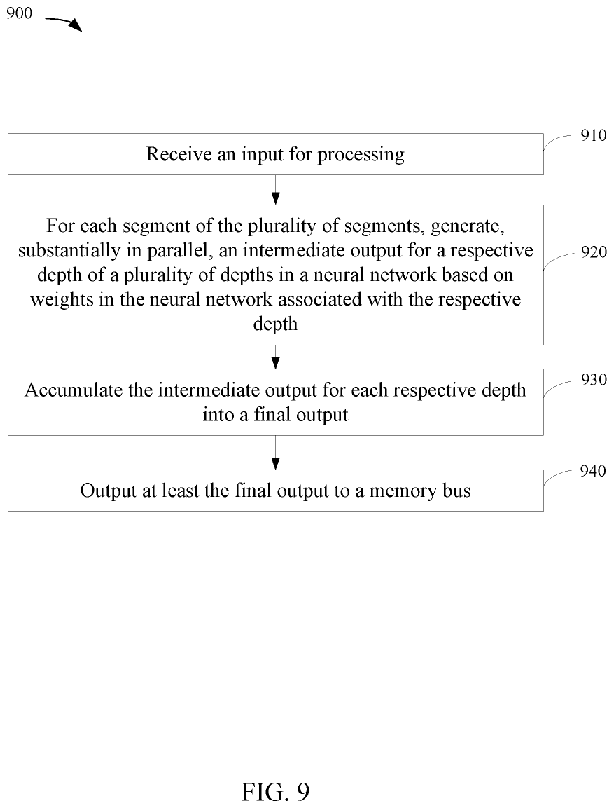

FIG. 9 is a flow diagram illustrating example operations 900 for neural network processing, in accordance with certain aspects of the present disclosure. The operations 900 may be performed, for example, by a neural-network-processing circuit, such as the neural-network-processing architecture 500 of FIG. 5 or FIG. 7.

Operations 900 may begin at block 910 by receiving an input for processing. The input may be a multidimensional array of data or a multidimensional tensor which may be segmented for parallel processing in a neural network.

In some aspects, the input may include data corresponding to a three-dimensional space. A first dimension in the three-dimensional space may correspond to a horizontal dimension. A second dimension in the three-dimensional space may correspond to a vertical dimension. A third dimension in the three-dimensional space may correspond to a depth dimension. For example, the three-dimensional space may be a Euclidean space in which data is represented in terms of height, width, and depth dimensions, such as data from a three-dimensional image of an object. In another example, the three-dimensional space may include spatial data on a two-dimensional plane, with the third dimension corresponding to a temporal channel in the input. This three-dimensional data may include, for example, video data, audio data, or other information in which time is a dimension.

In some aspects, the input may include a plurality of segments. For example, the segments may be sized such that that the same portions of the input can be processed in parallel, or substantially in parallel, at different depths of a neural network. Each segment of the plurality of segments may be, for example, a same block of pixels (e.g., in terms of horizontal and vertical coordinates) in different images corresponding to different depths in a three-dimensional image or to different timestamps in temporal data (e.g., different frames in a video). In some aspects, the plurality of segments may be based on a tiling used to define how a neural network is to process the input. Each segment of the plurality of segments may represent a sub-portion, or tile, of the input, the size of which may be defined by the number of tiles into which the input is divided. For example, for a number i of tiles, an image input with X pixels on the horizontal axis and Y pixels on the vertical axis may be divided into tiles of size (X*Y)/i pixels.

At block 920, for a segment of the plurality of segments of the input, an intermediate output is generated, substantially in parallel, at each of a plurality of depths in the neural network. The intermediate output may be generated based on weights in a neural network associated with filter or kernel used to process a portion of an input at a given depth in the neural network.

In some aspects, generating the intermediate output may include generating the intermediate output through a multiply-and-accumulate (MAC) circuit. The value generated by the MAC circuit may be stored in a tap register. In some aspects, generating the intermediate output may further include shifting a value in the tap register during each of a plurality of processing cycles.

At block 930, for the segment of the plurality of segments of the input, each intermediate output is accumulated into a final output. In some aspects, accumulating the intermediate outputs into a final output may include accumulating shifted values from tap registers associated with each of the respective values over a plurality of processing cycles. As discussed, the plurality of processing cycles may correspond to the number of depths being processed in parallel in a neural processing unit.

At block 940, at least the final output is output to a memory bus. In some aspects, the final output may be output to the memory bus based on a signal indicating that processing has been completed for a threshold number of depth cycles. By outputting the final output to the memory bus based on this signal, incomplete data may not be placed on the bus.

As discussed, the memory bus may be a selective bus that allows for selective dispatch or availability of data to a digital post processing block for further use. In some aspects, each intermediate output may also be output to the memory bus. The memory bus may selectively make values available to the digital post-processing block based, for example, on information about how an input is tiled for processing in a neural network.

### Example Device with Depth-Parallel Processing

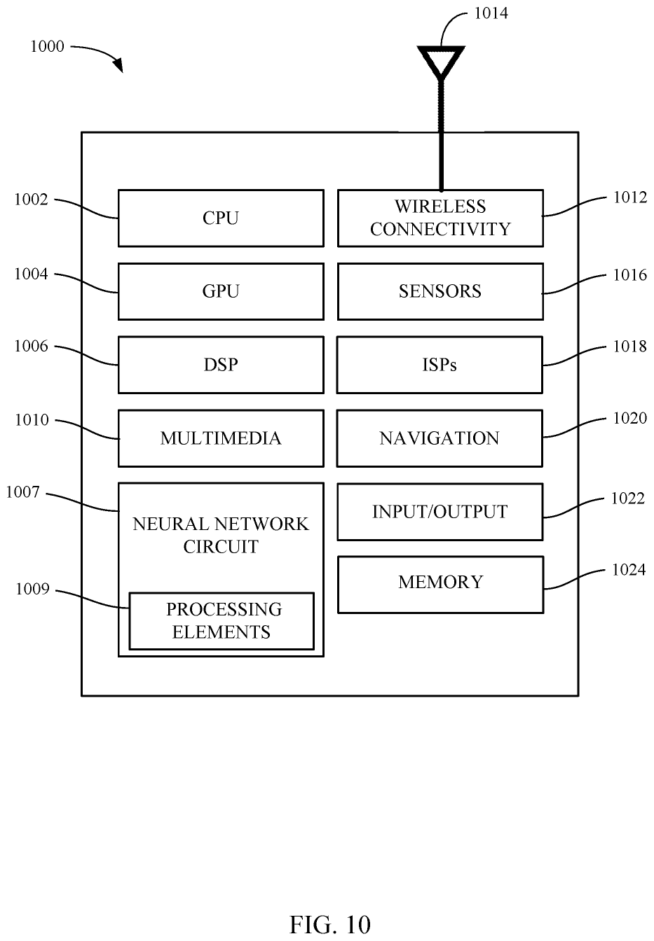

FIG. 10 illustrates an example electronic device 1000. The electronic device 1000 may be configured to perform the methods described herein, including the operations 900 described with respect to FIG. 9.

The electronic device 1000 includes a central processing unit (CPU) 1002, which in some aspects may be a multi-core CPU. Instructions executed at the CPU 1002 may be loaded, for example, from a program memory associated with the CPU 1002 or may be loaded from a memory 1024.

The electronic device 1000 also includes additional processing blocks tailored to specific functions, such as a graphics processing unit (GPU) 1004, a digital signal processor (DSP) 1006, a neural network circuit 1007 with a set of PEs 1009 to implement depth-parallel processing of inputs to the neural network circuit, a multimedia processing block 1010, and a wireless connectivity processing block 1012. In one implementation, the neural network circuit 1007 is implemented in one or more of the CPU 1002, GPU 1004, and/or DSP 1006.

In some aspects, the wireless connectivity processing block 1012 may include components, for example, for Third-Generation (3G) connectivity, Fourth-Generation (4G) connectivity (e.g., 4G LTE), Fifth-Generation connectivity (e.g., 5G or NR), Wi-Fi connectivity, Bluetooth connectivity, and/or wireless data transmission standards. The wireless connectivity processing block 1012 is further connected to one or more antennas 1014 to facilitate wireless communication.

The electronic device 1000 may also include one or more sensor processors 1016 associated with any manner of sensor, one or more image signal processors (ISPs) 1018 associated with any manner of image sensor, and/or a navigation processor 1020, which may include satellite-based positioning system components (e.g., Global Positioning System (GPS) or Global Navigation Satellite System (GLONASS)), as well as inertial positioning system components.

The electronic device 1000 may also include one or more input and/or output devices 1022, such as screens, touch-sensitive surfaces (including touch-sensitive displays), physical buttons, speakers, microphones, and the like. In some aspects, one or more of the processors of the electronic device 1000 may be based on an Advanced RISC Machines (ARM) instruction set, where RISC stands for “reduced instruction set computing.”

The electronic device 1000 also includes memory 1024, which is representative of one or more static and/or dynamic memories, such as a dynamic random access memory (DRAM), a flash-based static memory, and the like. In this example, memory 1024 includes computer-executable components, which may be executed by one or more of the aforementioned processors of the electronic device 1000, including the neural network circuit 1007. The depicted components, and others not depicted, may be configured to perform various aspects of the methods described herein.

In some aspects, such as where the electronic device 1000 is a server device, various aspects may be omitted from the example depicted in FIG. 10, such as one or more of the multimedia processing block 1010, wireless connectivity processing block 1012, antenna(s) 1014, sensor processors 1016, ISPs 1018, or navigation processor 1020.

### Example Clauses

In addition to the various aspects described above, specific combinations of aspects are within the scope of the disclosure, some of which are detailed in the clauses below:

Clause 1: A processing circuit comprising a plurality of groups of processing element (PE) circuits, wherein: each group of PE circuits comprises a plurality of PE circuits configured to process in parallel an input at a plurality of depths, and each PE circuit comprises: one or more multiplication circuits, each multiplication circuit being configured to calculate a partial product, and a local accumulator having an input coupled to an output of the one or more multiplication circuits, the local accumulator being configured to generate a sum from the partial product generated by each of the one or more multiplication circuits.

Clause 2: The processing circuit of Clause 1, wherein each PE circuit further comprises: a register having an input coupled to an output of the local accumulator.

Clause 3: The processing circuit of Clause 2, further comprising a plurality of global accumulators, wherein an output of the register in each PE circuit is coupled to the input of another register in another PE circuit in the group of PE circuits or to an input of one of the global accumulators.

Clause 4: The processing circuit of Clause 3, further comprising a bus, wherein another output of the register in each PE circuit is coupled to the bus.

Clause 5: The processing circuit of Clause 4, wherein an output of each of the global accumulators is further coupled to the bus.

Clause 6: The processing circuit of any of Clauses 2 through 5, wherein each PE circuit further comprises a first selection circuit having a first input coupled to the output of the local accumulator and having an output coupled to the input of the register.

Clause 7: The processing circuit of Clause 6, wherein the first selection circuit in each PE circuit has a second input coupled to an output of the register.

Clause 8: The processing circuit of Clause 7, wherein the first selection circuit comprises a 2:1 multiplexer, a tri-state buffer, or a plurality of switches.

Clause 9: The processing circuit of any one of Clauses 6 through 8, wherein at least some of the PE circuits in each group of PE circuits further comprise a second selection circuit having an output coupled to the input of the register, having a first input coupled to an output of the register, and having a second input coupled to an output of another register in another PE circuit in the group of PE circuits.

Clause 10: The processing circuit of Clause 9, wherein the second selection circuit comprises a 2:1 multiplexer, a tri-state buffer, or a plurality of switches.

Clause 11: The processing circuit of any of Clauses 1 through 10, further comprising a plurality of global accumulators, wherein each global accumulator has an input coupled to an output of one of the groups of PE circuits.

Clause 12: The processing circuit of any of Clauses 1 through 11, wherein the plurality of PE circuits is further configured to process in parallel a plurality of depths of a plurality of inputs.

Clause 13: A method of neural network processing, comprising: receiving an input for processing; and for each segment of a plurality of segments of the received input: generating, substantially in parallel, an intermediate output for a respective depth of a plurality of depths in a neural network based on weights in the neural network associated with the respective depth in the neural network; accumulating the intermediate output for each respective depth into a final output; and outputting the final output to a memory bus.

Clause 14: The method of Clause 13, wherein: the input comprises data from a three-dimensional space, a first dimension in the three-dimensional space corresponds to a horizontal dimension, a second dimension in the three-dimensional space corresponds to a vertical dimension, and a third dimension in the three-dimensional space corresponds to a depth dimension.

Clause 15: The method of Clause 14, wherein: the data from the three-dimensional space comprises video data, and the depth dimension corresponds to a temporal channel in the video data.

Clause 16: The method of any of Clauses 13 through 15, wherein generating the intermediate output for the respective depth in the neural network comprises: generating the intermediate output through a multiply-and-accumulate (MAC) circuit; and storing a value of the MAC circuit in a tap register.

Clause 17: The method of Clause 16, wherein generating the intermediate output for the respective depth in the neural network further comprises shifting the value in the tap register during each of a plurality of processing cycles.

Clause 18: The method of any of Clauses 13 through 17, wherein accumulating the intermediate output for each respective depth into the final output comprises accumulating shifted values associated with each of the respective depths over a plurality of processing cycles stored in one or more tap registers.

Clause 19: The method of any of Clauses 13 through 18, wherein outputting the final output to the memory bus comprises outputting, each intermediate output to the memory bus.

Clause 20: The method of any of Clauses 13 through 19, wherein outputting the final output to the memory bus is based on a signal indicating that processing has been completed for a threshold number of depth cycles.

Clause 21: An apparatus, comprising: a memory bus, a digital post-processing block, and a processor configured to perform the operations of any of Clauses 13 through 20.

Clause 22: An apparatus, comprising: means for performing the operations of any of Clauses 13 through 20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. Example means-plus-function components may include means for receiving, means for generating, means for accumulating, and means for outputting, among others. The means for receiving may include an input/output block, such as the input/output block 1012 depicted in FIG. 10, a wireless communications block (e.g., transceiver), such as the wireless communication block 1012 depicted in FIG. 10, among others. The means for generating may include one or more processors or processing circuits, such as the neural network circuit 1007 and/or processing elements 1009 illustrated in FIG. 10. The means for accumulating may include one or more processors or processing circuits, such as the neural network circuit 1007 and/or processing elements 1009 portrayed in FIG. 10. The means for outputting may include an input/output block, such as the input/output block 1012 depicted in FIG. 10, a wireless communications block (e.g., transceiver), such as the wireless communication block 1012 depicted in FIG. 10, among others.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing circuit comprising a plurality of groups of processing element (PE) circuits, wherein:
each group of PE circuits comprises a plurality of PE circuits configured to process in parallel an input at a plurality of depths, and
each PE circuit comprises:
one or more multiplication circuits, each multiplication circuit being configured to calculate a partial product, and
a local accumulator having an input coupled to an output of the one or more multiplication circuits, the local accumulator being configured to generate a sum from the partial product calculated by each of the one or more multiplication circuits.

2. The processing circuit of claim 1, wherein each PE circuit further comprises:
a register having an input coupled to an output of the local accumulator.

3. The processing circuit of claim 2, further comprising a plurality of global accumulators, wherein an output of the register in each PE circuit is coupled to the input of another register in another PE circuit in the group of PE circuits or to an input of one of the global accumulators.

4. The processing circuit of claim 3, further comprising a bus, wherein another output of the register in each PE circuit is coupled to the bus.

5. The processing circuit of claim 4, wherein an output of each of the global accumulators is further coupled to the bus.

6. The processing circuit of claim 2, wherein each PE circuit further comprises a first selection circuit having a first input coupled to the output of the local accumulator and having an output coupled to the input of the register.

7. The processing circuit of claim 6, wherein the first selection circuit in each PE circuit has a second input coupled to an output of the register.

8. The processing circuit of claim 7, wherein the first selection circuit comprises a 2:1 multiplexer, a tri-state buffer, or a plurality of switches.

9. The processing circuit of claim 6, wherein at least some of the PE circuits in each group of PE circuits further comprise a second selection circuit having an output coupled to the input of the register, having a first input coupled to an output of the register, and having a second input coupled to an output of another register in another PE circuit in the group of PE circuits.

10. The processing circuit of claim 9, wherein the second selection circuit comprises a 2:1 multiplexer, a tri-state buffer, or a plurality of switches.

11. The processing circuit of claim 1, further comprising a plurality of global accumulators, wherein each global accumulator has an input coupled to an output of one of the groups of PE circuits.

12. The processing circuit of claim 1, wherein the plurality of PE circuits is further configured to process in parallel a plurality of inputs at a plurality of depths.

13. A method of neural network processing, comprising:
receiving an input for processing; and
for each segment of a plurality of segments of the received input:
generating, substantially in parallel, a respective intermediate output for a respective depth of a plurality of depths in a neural network based on weights in the neural network associated with the respective depth in the neural network;
accumulating the intermediate output for each respective depth into a final output; and
outputting the final output to a memory bus.

14. The method of claim 13, wherein:
the input comprises data from a three-dimensional space,
a first dimension in the three-dimensional space corresponds to a horizontal dimension,
a second dimension in the three-dimensional space corresponds to a vertical dimension, and
a third dimension in the three-dimensional space corresponds to a depth dimension.

15. The method of claim 14, wherein:
the data from the three-dimensional space comprises video data, and
the depth dimension corresponds to a temporal channel in the video data.

16. The method of claim 13, wherein generating the intermediate output for the respective depth in the neural network comprises:
generating the intermediate output through a multiply-and-accumulate (MAC) circuit; and
storing a value of the MAC circuit in a tap register.

17. The method of claim 16, wherein generating the intermediate output for the respective depth in the neural network further comprises shifting the value in the tap register during each of a plurality of processing cycles.

18. The method of claim 13, wherein accumulating the intermediate output for each respective depth into the final output comprises accumulating shifted values associated with each of the respective depths over a plurality of processing cycles stored in one or more tap registers.

19. The method of claim 13, wherein outputting the final output to the memory bus comprises outputting each intermediate output to the memory bus.

20. The method of claim 13, wherein outputting the final output to the memory bus is based on a signal indicating that processing has been completed for a threshold number of depth cycles.

21. An apparatus, comprising:
a memory bus;
a processor configured to:
receive an input for processing; and
for each segment of a plurality of segments of the received input:
generate, substantially in parallel, a respective intermediate output for a respective depth of a plurality of depths in a neural network based on weights in the neural network associated with the respective depth in the neural network;
accumulate the intermediate output for each respective depth into a final output; and
output the final output to the memory bus; and
a digital post-processing block configured to retrieve the final output from the memory bus and perform one or more operations based on the final output.

22. The apparatus of claim 21, wherein:
the input comprises data from a three-dimensional space,
a first dimension in the three-dimensional space corresponds to a horizontal dimension,
a second dimension in the three-dimensional space corresponds to a vertical dimension, and
a third dimension in the three-dimensional space corresponds to a depth dimension.

23. The apparatus of claim 22, wherein:
the data from the three-dimensional space comprises video data, and
the depth dimension corresponds to a temporal channel in the video data.

24. The apparatus of claim 21, wherein in order to generate the intermediate output for the respective depth in the neural network, the processor is configured to:
generate the intermediate output through a multiply-and-accumulate (MAC) circuit; and
store a value of the MAC circuit in a tap register.

25. The apparatus of claim 24, wherein in order to generate the intermediate output for the respective depth in the neural network, the processor is further configured to shift the value in the tap register during each of a plurality of processing cycles.

26. The apparatus of claim 21, wherein in order to accumulate the intermediate output for each respective depth into the final output, the processor is configured to accumulate shifted values associated with each of the respective depths over a plurality of processing cycles stored in one or more tap registers.

27. The apparatus of claim 21, wherein in order to output the final output to the memory bus, the processor is configured to output, for each intermediate output value to the memory bus.

28. The apparatus of claim 21, wherein in order to output the final output to the memory bus, the processor is configured to output the final output based on a signal indicating that processing has been completed for a threshold number of depth cycles.

29. An apparatus comprising:
means for receiving an input for processing;
means for generating, for each segment of a plurality of segments of the received input and substantially in parallel, an intermediate output for a respective depth of a plurality of depths in a neural network based on weights in a neural network associated with the respective depth in the neural network;
means for accumulating, for each segment of a plurality of segments of the received input, the intermediate output for each respective depth into a final output; and
means for outputting, for each segment of a plurality of segments of the received input, the final output to a memory bus.
